(19) United States
(12) Patent Application Publication
(10) Pub. No.: US 2014/0307551 A1
(43) Pub. Date: Oct. 16, 2014

(54) AUTOMATIC LEARNING OF WI-FI NEIGHBORS AND NETWORK CHARACTERISTICS

(71) Applicant: NOKIA SIEMENS NETWORKS OY, Espoo (FI)

(72) Inventor: Mika FORSSELL, Soderkulla (FI)

(21) Appl. No.: 13/862,099

(22) Filed: Apr. 12, 2013

(51) Int. Cl. H04W 28/08; H04W 24/10; H04W 36/00

(52) U.S. Cl. CPC H04W 28/08; H04W 36/0022; H04W 24/10
USPC 370/235; 370/338; 370/331

(57) ABSTRACT

Communication systems may benefit from additional network information. For example, certain networks or user equipment may benefit from automatic learning of Wi-Fi neighbors and network characteristics. A method may include monitoring network neighborhood for a non-cellular access point. The method may also include storing an identifier of a non-cellular access point. The method may further include associating at least one characteristic of the non-cellular access point with the identifier. The method may additionally include reporting the identifier and the at least one characteristic.

### BACKGROUND

1. Field

Communication systems may benefit from additional network information. For example, certain networks or user equipment may benefit from automatic learning of Wi-Fi neighbors and network characteristics.

2. Description of the Related Art

Non-cellular radio access technologies, such as Wi-Fi networks, are becoming an integral part of mobile broadband. Wi-Fi is already standard feature on smart phones, tablets and laptops and is used by many network operators. However, despite the popularity of Wi-Fi, operators lack a measure of control and lack dynamic mechanisms for determining user device movement between mobile and Wi-Fi networks.

Conventionally an operator can only manually configure each eNode B (eNB)/radio network controller (RNC)/base station controller (BSC) as to whether are Wi-Fi networks around and the characteristics of the networks. Thus, in such cases Radio Resource Manager (RRM) in these network elements may be able also to consider Wi-Fi as part of traffic steering decisions for example as part of 3GPP rel-12 or rel-13 RAN/Wi-Fi Interworking. However, some operators already have millions of hotspots, and there may be an interest in permitting further hotspots to be added easily.

LTE Automated Neighboring Relations (ANR) enables eNB to use user equipment (UE) provided measurement reports to learn neighboring cells. There is not, however, any such conventional mechanism for Wi-Fi.

### SUMMARY

According to a first embodiment, a method can include monitoring network neighborhood for a non-cellular access point. The method can also include storing an identifier of a non-cellular access point. The method can further include associating at least one characteristic of the non-cellular access point with the identifier. The method can additionally include reporting the identifier and the at least one characteristic.

According to a second embodiment, a method can include receiving a report comprising an identifier of a non-cellular access point and at least one characteristic associated with the non-cellular access point. The method can also include creating an association of the identifier, the at least one characteristic, and a location of the non-cellular access point, based on the report.

According to a third embodiment, a method can include detecting an off-loading condition in an area of a radio access network. The method can also include determining whether non-cellular access meeting required characteristics is available. The method can further include selecting a user equipment for moving to non-cellular access based on the detecting and determining.

According to a fourth embodiment, a method can include determining whether a user equipment is within coverage of non-cellular access meeting required characteristics. The method can also include deciding whether to off-load the user equipment from a cellular access network based on the determining.

According to a fifth embodiment, an apparatus can include at least one processor and at least one memory including computer program code. The at least one memory and the computer program code can be configured to, with the at least one processor, cause the apparatus at least to monitor network neighborhood for a non-cellular access point. The at least one memory and the computer program code can also be configured to, with the at least one processor, cause the apparatus at least to store an identifier of a non-cellular access point. The at least one memory and the computer program code can further be configured to, with the at least one processor, cause the apparatus at least to associate at least one characteristic of the non-cellular access point with the identifier. The at least one memory and the computer program code can additionally be configured to, with the at least one processor, cause the apparatus at least to report the identifier and the at least one characteristic.

According to a sixth embodiment, an apparatus can include at least one processor and at least one memory including computer program code. The at least one memory and the computer program code can be configured to, with the at least one processor, cause the apparatus at least to receive a report comprising an identifier of a non-cellular access point and at least one characteristic associated with the non-cellular access point. The at least one memory and the computer program code can also be configured to, with the at least one processor, cause the apparatus at least to create an association of the identifier, the at least one characteristic, and a location of the non-cellular access point, based on the report.

According to a seventh embodiment, an apparatus can include at least one processor and at least one memory including computer program code. The at least one memory and the computer program code can be configured to, with the at least one processor, cause the apparatus at least to detect an off-loading condition in an area of a radio access network. The at least one memory and the computer program code can also be configured to, with the at least one processor, cause the apparatus at least to determine whether non-cellular access meeting required characteristics is available. The at least one memory and the computer program code can further be configured to, with the at least one processor, cause the apparatus at least to select a user equipment for moving to non-cellular access based on the detected off-loading condition and the determined availability of non-cellular access meeting required characteristics.

According to an eighth embodiment, an apparatus can include at least one processor and at least one memory including computer program code. The at least one memory and the computer program code can be configured to, with the at least one processor, cause the apparatus at least to determine whether a user equipment is within coverage of non-cellular access meeting required characteristics. The at least one memory and the computer program code can also be configured to, with the at least one processor, cause the apparatus at least to decide whether to off-load the user equipment from a cellular access network based on the determining.

According to a ninth embodiment, an apparatus can include monitoring means for monitoring network neighborhood for a non-cellular access point. The apparatus can also include storing means for storing an identifier of a non-cellular access point. The apparatus can further include associating means for associating at least one characteristic of the non-cellular access point with the identifier. The apparatus can additionally include reporting means for reporting the identifier and the at least one characteristic.

According to a tenth embodiment, an apparatus can include receiving means for receiving a report comprising an identifier of a non-cellular access point and at least one characteristic associated with the non-cellular access point. The apparatus can also include creating means for creating an association of the identifier, the at least one characteristic, and a location of the non-cellular access point, based on the report.

According to an eleventh embodiment, an apparatus can include detecting means for detecting an off-loading condition in an area of a radio access network. The apparatus can also include determining means for determining whether non-cellular access meeting required characteristics is available. The apparatus can further include selecting means for selecting a user equipment for moving to non-cellular access based on the detecting and determining.

According to a twelfth embodiment, an apparatus can include determining means for determining whether a user equipment is within coverage of non-cellular access meeting required characteristics. The apparatus can also include deciding means for deciding whether to off-load the user equipment from a cellular access network based on the determining.

According to thirteenth through sixteenth embodiments respectively, a non-transitory computer-readable medium is encoded with instructions that, when executed in hardware, perform a process. The process can include the method respectively according to the methods of the first through fourth embodiments.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates another method according to certain embodiments.

FIG. 3 illustrates an example architecture in which ANDSF server receives UE report and provides meaningful information to RAN.

FIG. 4 illustrates a system according to certain embodiments of the invention.

FIG. 5 illustrates a method according to certain embodiments.

FIG. 6 illustrates a method according to further embodiments.

FIG. 7 illustrates a method according to other embodiments.

FIG. 8 illustrates a method according to certain further embodiments.

### DETAILED DESCRIPTION

Certain embodiments may provide operators with tools to perform various functions. For example, certain embodiments may help operators balance traffic between mobile and Wi-Fi networks to improve user experience and avoid congestion on one of the networks. Moreover, certain embodiments may help to perform 3G/LTE cell congestion based offload to Wi-Fi to improve user experience and use Wi-Fi as a backup capacity when needed. Furthermore, for example, certain embodiments may permit offloading UE to roaming partner Wi-Fi costing extra for the operator only when own network, mobile and optionally own Wi-Fi hotspots, does not have enough available capacity, like during a mass event. Likewise, certain embodiments may permit operators to help ensure a suitable level of customer experience and to offload to Wi-Fi only when cell becomes congested

Certain embodiments may provide a way for a radio access network to automatically identify where the Wi-Fi networks are located and the characteristics of the different local Wi-Fi networks. By knowing this, RAN may avoid wasting resources on issuing network selection commands, such as offload command to Wi-Fi, to UEs where Wi-Fi is not expected to be available or does not meet quality standards, for example, a roaming partner Wi-Fi that should not be used for a gold user.

Certain embodiments provide a mechanism that enables RAN automatically to learn availability/location of Wi-Fi networks and/or characteristics of the Wi-Fi networks. This may enable the RAN to avoid considering Wi-Fi as part of traffic steering/RRM decisions where Wi-Fi network is not available or Wi-Fi network does not fulfill set requirements, like quality or feature. As a result, communication with the UE can be optimized and unnecessary communication can be avoided. Moreover, manual configuration effort can be avoided and HetNet networks can be operated more efficiently.

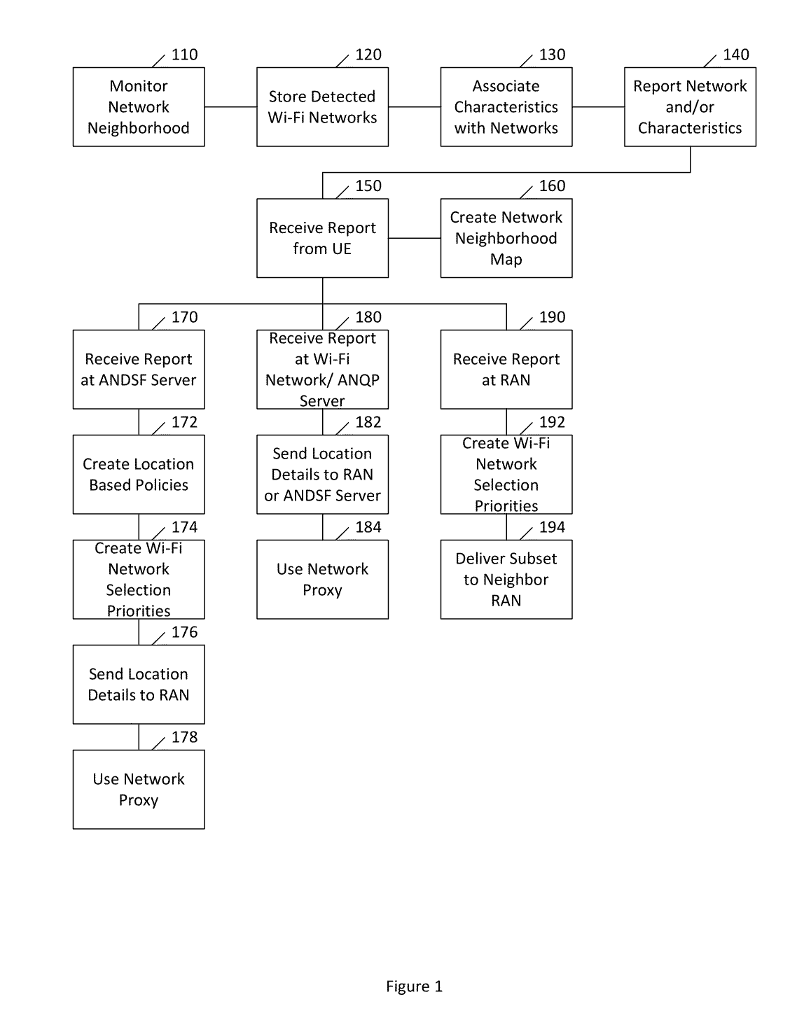

FIG. 1 illustrates a method according to certain embodiments. As shown in FIG. 1, at 110, a UE can monitor its network neighborhood during operation. For example, the UE can perform a periodic scan to detect available Wi-Fi networks. The UE can, at 120, store either all detected Wi-Fi networks or only selected Wi-Fi networks, for example those Wi-Fi networks defined as “operator approved” by including the Wi-Fi networks into Access Network Discovery and Selection Function (ANDSF) policies, Hotspot 2.0 Access Network Query Protocol (ANQP) information or configuring the networks to UE using other means, for example, device management based over the air configuration or configuring approved Wi-Fi networks into UE before selling the UE to the user. The UE can store either only information related to used Wi-Fi networks or from all detected Wi-Fi networks even if the UE hasn't been connected to the networks or even if the UE has not used the Wi-Fi networks for data transmission. The selection of all or selected Wi-Fi networks are monitored can be determined e.g. via standard definition (for example ANDSF standard) or an operator can dynamically activate/deactivate monitoring functionality in the UE, by using for example ANDSF, Hotspot 2.0 ANQP communication, Device Management or local UE configuration (SIM card, local configuration file, separate UE client SW with configuration data).

In addition to detecting available networks and their location, as an option the UE can, at 130, associate performance, quality and feature characteristics of the detected Wi-Fi networks or single Wi-Fi APs to the Wi-Fi networks or single Wi-Fi APs. A Wi-Fi network, for example, service set identifier (SSID)=operatorX can include a number of APs.

These characteristics can include, for example, supported authentication methods, like EAP-SIM, EAP-AKA, EAP-AKA′, 802.1x, Captive portal, open etc. The characteristics can also include, for example, all or a subset of Hotspot 2.0 ANQP information. Subset information, not limited to only ANQP, can include, for example, service provider Fully Qualified Domain Name (FQDN), roaming consortium OI, list of operator friendly names, public land mobile network (PLMN) identifier reachable through the Wi-Fi network, performance data (like AP load and/or bitrate indicator, WAN (Wide Area Network) metrics including, for example, uplink/downlink speed and load), etc. The UE may be able to measure many of these characteristics or properties itself. The characteristics can further include supported radio technologies, like 802.11a/b/g/n etc. The characteristics can further include supported connection capabilities, like list of supported protocols and ports, such as those ports not blocked by a firewall. The characteristics can additionally include UE measured experience. For example, when the UE has been connected to a Wi-Fi AP the UE can monitor real Wi-Fi AP performance, such as experienced bitrate, delay, number of erroneous radio messages, radio quality etc. Other characteristics can also be considered. Also when being connected to a Wi-Fi network, the UE may measure which protocols, ports, services (such as VoIP, HTTP, SIP, streaming, video, and the like), etc. are supported via the network and not, for example, blocked by firewall or suffering from downgraded service experience e.g. due to supported bitrates.

At 140, the UE can report Wi-Fi AP/network location information and optionally characteristics to the network upon request, periodically or at a next time when the UE is communicating with the network. The way that the reporting occurs can vary. As an option, the UE may group Wi-Fi information provided in a report. For example if the UE can detect Wi-Fi APs with SSID=a, SSID=b and SSID=c at the same time, the UE may group these SSIDs indicating to the network the networks were available on the same area.

In case of ANDSF, the UE can report the results (such as AP location (cell id, tracking/location/routing area id, GPS etc.) and/or characteristics) within ANDSF messages exchanged with the ANDSF server.

In case of Hotspot 2.0 ANQP, the UE can report the results (such as AP location and/or characteristics) within 802.11u/Hotspot 2.0 messages exchanged with the Wi-Fi network and/or ANQP server, or basically any 802.11 defined messaging can be used between the UE and the Wi-Fi network.

Further, the UE can report the results (such as AP location and/or characteristics) within a 3GPP message, for example Radio Resource Control (RRC). For example, when the UE sends a measurement report to the RAN (eNB/RNC/BSC) the UE can also include Wi-Fi information in the measurement report message. Or when the UE/network establishes a bearer, PDP context or session or modifies/updates any of these (for example, when the UE negotiates new characteristics like QoS for a bearer/context/session), Wi-Fi information may be included in the message the UE transmits to the network. This information may include information like detected Wi-Fi APs, Wi-Fi AP IDs (like SSID/FQDN and/or medium access control (MAC) address), their location and characteristics, such as measured radio quality of the Wi-Fi APs or supported performance of the Wi-Fi APs. These examples of information are just examples, and any characteristics information, as discussed above, is permitted.

At 150, a network element can receive the UE Wi-Fi results. For example, the network element may be ANDSF server, Wi-Fi network (like Wi-Fi Controller), ANQP server, or RAN (eNB, RNC, BSC, centralized RRM etc,). In one example the network may also be a network element in a core network, for example an MME or PGW (the UE may use a mobility/session management message), enabling the MME to manage the Wi-Fi information, in a similar way as described for example for ANDSF server. Then, at 160, the network element receiving UE Wi-Fi results stores the results.

At 160, the network element can use the results, for example, to create a network neighborhood map. This map can define the locations where Wi-Fi APs are available. For example, in Amsterdam train station, which can be defined by map based location, GPS, address information (for example using location info and Google maps service to get a street address) or cell IDs (optionally also location area ID, tracking area ID or routing area ID can be used), there may be twelve Wi-Fi APs available which are own hotspots (SSID, FQDN, PLMN, etc.) and in addition there may be six Wi-Fi APs available belonging to roaming partners having roaming agreement with home operator.

Based on street address/GPS/Cell ID etc. mapping to Wi-Fi APs, the network may be able to tell when UE is located in certain area which Wi-Fi APs are, should be, or are expected to be available on that area. Optionally, the network can associate Wi-Fi AP/network characteristics with the Wi-Fi APs/networks. This can allow the network to know, for example, that in Amsterdam train station own hotspots are good quality hotspots for which the user has authentication credentials and that may be used also for gold/platinum subscribers. Or in case the network has received in short period of time reports indicating own hotspots are congested in Amsterdam train station (reports indicate poor Wi-Fi performance), the network may determine temporary congestion in own hotspots in general well working own hotspots providing good quality (thus avoiding further use of the own hotspots for time being).

At 170, in case of an ANDSF server receiving the UE report, the ANDSF server may use the UE report internally to automatically, at 172, create location based policies influencing UE 3GPP/Wi-Fi network selection policies only in some area. This may be valuable to an operator who needs to manage numerous cities, roaming partners, and the like.

Moreover, at 174, the ANDSF server can create Wi-Fi network selection priorities, for example ANDSF server can decrease priority (or prevent utilization) for Wi-Fi networks performing poorly or not supporting 802.1x based authentication enabling automated login to the Wi-Fi network.

Furthermore, at 176, the ANDSF server may send the Wi-Fi AP/network location details and optionally characteristics details to RAN (or ANQP server or another server benefiting from the information). This enables the RAN to know which Wi-Fi networks, and characteristics, are available in the area served by the RAN. For example the RAN may associate the Wi-Fi APs/networks to cell IDs and therefore know exactly which Wi-Fi networks could be considered as part of traffic steering/RRM/offload decisions made by the RAN.

The ANDSF server may have preconfigured information regarding which areas are covered by which RAN network elements to avoid delivering all information to every RAN (RAN serves a defined geographical area limited by wireless coverage). As an option, the ANDSF server may, at 178, use a network proxy server, for example an MME or a “master-RAN”, to determine which information is meaningful for which particular RAN. For example, a RAN serving the Amsterdam area does not need to know Wi-Fi details in Rotterdam. As one example, if UE reports Wi-Fi network information to the ANDSF server using mobile network, ANDSF communication can be identified by RAN (for example, eNB, RNC, or BSC), SGW, PGW or another network element, for example by using DPI like functionality). The received information can cause the network element to add (piggyback) an extra “network area identifier” to the message sent to the ANDSF server allowing the ANDSF server to utilize the extra network area identifier to send the Wi-Fi information details decoded from the ANDSF message back to the correct RAN. For example, the network area identifier may be an IP address of an eNB or RNC or some centralized radio resource management element. As another example, there may be also an internal mapping table enabling mapping of certain areas to a RAN. For example, CellId1 . . . 100 may be mapped with tracking area ID 12 belong to RAN1. As another example, DNS may be used to map area identifiers to IP addresses of RAN serving an area (e.g. operatorx.ci.tac.com->IP address, where operatorx is operator ID (e.g. mobile country code and mobile network code), ci is cell identifier and tac is Tracking Area Identifier).

At 180, when a Wi-Fi network/ANQP server receives the UE report, the ANQP server may use the UE report internally to automatically create a network neighborhood map and identify which Wi-Fi AP is close to which Wi-Fi AP that may be later used to optimize mobility across APs, report neighbors to UE or network elements etc.

Then, at 182, the ANQP server may send the Wi-Fi AP/network location details and optionally characteristics details to RAN, or ANDSF server (or any other network entity benefiting from the information). The ANDSF server may utilize the report as discussed above. This may enable the RAN to know which Wi-Fi networks, and characteristics, are available in the area served by the RAN. For example the RAN may associate the Wi-Fi APs/networks to cell IDs and therefore know exactly which Wi-Fi networks could be considered as part of traffic steering/RRM/offload decisions made by the RAN.

The ANQP server may have preconfigured information regarding which areas are covered by which RAN network elements, to avoid delivering all information to every RAN. As an option, at 184, the ANQP server may use “network proxy,” for example a mobility management entity (MME) or “master-RAN,” to determine which information is meaningful for which particular RAN. For example, a RAN serving the Amsterdam area does not need to know Wi-Fi details in Rotterdam. As one example, DNS mapping process described earlier can be utilized.

At 190, when a RAN receives a UE report directly, the RAN may use the UE report internally to automatically create neighborhood map and associate which Wi-FI APs are available in which areas. For example, these Wi-Fi APs can be identified as being located within the coverage area of cell=X. At 192, the RAN can create Wi-Fi network selection characteristics/priorities, for example identify good quality and bad quality networks and/or identify which operators and services are available via which Wi-Fi APs. The RAN may, at 194, deliver (a subset of) the received report to a neighboring RAN, for example if these two RANs have cells with overlapping coverage.

As another example, the network can learn by itself without UE assistance the location and characteristics of Wi-Fi networks and report these to ANDSF server, ANQP server, RAN (for example, eNB, RNC, BSC, centralized radio resource manager element/functionality) or to other servers or network elements. For example a Wi-Fi AP may be aware of neighboring APs using IEEE specified mechanisms, for example to assist in mobility between Wi-Fi APs. Also an operator may define location for each deployed Wi-Fi AP into the AP/WLAN Controller/or other network element. Alternatively, Wi-Fi AP may have global positioning system (GPS) data attached to it enabling the AP to identify its location automatically. Also, the characteristics of a Wi-Fi AP may be known, for example by the Wi-Fi AP, ANQP server, WLAN Controller or another network element monitoring or managing the Wi-Fi network. Therefore the Wi-Fi network (like ANQP server, Wi-Fi AP, WLAN Controller, Wi-Fi GW etc.) may report Wi-Fi network characteristics from an area to the mobile network (ANDSF server, RAN, MME, PGW, O&M etc.) enabling the mobile network to configure Wi-Fi neighbors into each RAN/Network element managing UE network selection between mobile and Wi-Fi networks. Identifying the mobile network element the reporting Wi-Fi network element communicates with can be done using the above described mechanisms (see e.g. ANDSF server) or an operator can pre-configure address information to the network element. For example WLAN Controller reports Wi-Fi information from Wi-Fi APs associated to the WLAN Controller to RAN1 (and RAN2) configured to the WLAN Controller.

Although in certain embodiments the mobile network can configure Wi-Fi neighbors into each RAN or other network element managing UE network selection between mobile and Wi-Fi networks, other embodiments are also possible. For example, the core network may have a role in which a centralized element or functionality is used to provide control of selection between mobile and Wi-Fi networks. This centralized element or functionality may be specifically configured for this function, or may be modified to include this function. For example, a mobility management entity (MME) may be configured to provide control of selection between mobile and Wi-Fi networks either directly or under management of another network element.

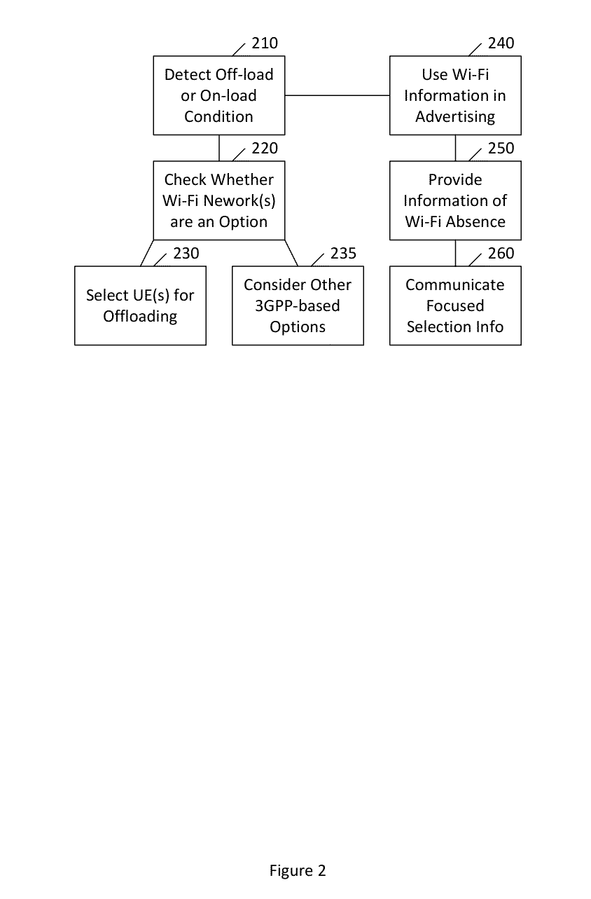

FIG. 2 illustrates another method according to certain embodiments. In such embodiments, a network and UE may execute UE 3GPP/Wi-Fi network selection control efficiently.

The RAN may detect, at 210, cell congestion, inability to maintain quality of service (QoS) or ability to maintain quality of experience (QoE), UE having poor radio quality because of location at cell edge/far from base station or the like condition. This may be considered detection of an off-load condition. Alternatively, the condition to be detected may be an on-load condition, relating to the possibility of adding an additional device or connection. For example RAN may use Wi-Fi network location and optionally characteristics information in determining if the RAN takes an effort in trying to move a UE using Wi-Fi network to mobile network and, for example, 3G/LTE small cells available in the same area.

Upon detection, at 220, RRM (here RRM is used to refer to a network functionality controlling/influencing if UE uses mobile or Wi-Fi network) in RAN may check if Wi-Fi networks are an option to utilize. This check may be based on location, availability, characteristics, and so on. When a Wi-Fi network is an option to utilize, at 230, the RRM may select UEs, for example some bronze or gold users, to be offloaded to the Wi-Fi network. Otherwise, at 235, the RRM can consider other 3GPP-based options, like handover (HO) between 3G and LTE, cell reselection, and the like.

There may be 3G-like tightly network controlled handovers between mobile and Wi-Fi. Thus, the LTE cell can advertise in SIB neighbor network information not only 3G/LTE neighbors but also the Wi-Fi networks. Thus, when Wi-Fi becomes tightly coupled to 3GPP cells, RAN may, at 240, use the Wi-Fi information as part of advertising neighbors to the UEs camped on the cell (for example, in SIB messages 2G/3G/LTE neighbor cell information can be complemented by Wi-Fi information) enabling the UEs to learn about neighboring Wi-Fi networks and optionally their characteristics. In addition to advertising LTE, 3G etc. cells, also Wi-Fi networks/APs can be advertised enabling the UEs to look for these networks as well, for example in Measurement Report Order/Control messages controlling which neighbors the UE shall look for and measure. The UE may also utilize the received information for example to guide Wi-Fi scanning procedures; more frequent scanning is done when Wi-Fi should be available, enable/disable Wi-Fi radio on certain area, and the like, to save battery and improve user experience.

At 250, the network, for example RAN or ANDSF server, may provide UE information where Wi-Fi is not available, enabling the UE to power off Wi-Fi radio. For example, such power down can occur when the UE knows there are not also home or enterprise Wi-Fi networks nearby configured to the UE, in addition to operator approved networks.

At 260, the ANDSF server may communicate focused network selection information to the UE. For example, for a UE belonging to a Finnish operator visiting Amsterdam, the ANDSF server can configure Wi-Fi network information valid for Amsterdam. Moreover, if, for example, there are different Wi-Fi service providers with roaming agreement available in Rotterdam, these may not be configured to the UE visiting Amsterdam by default.

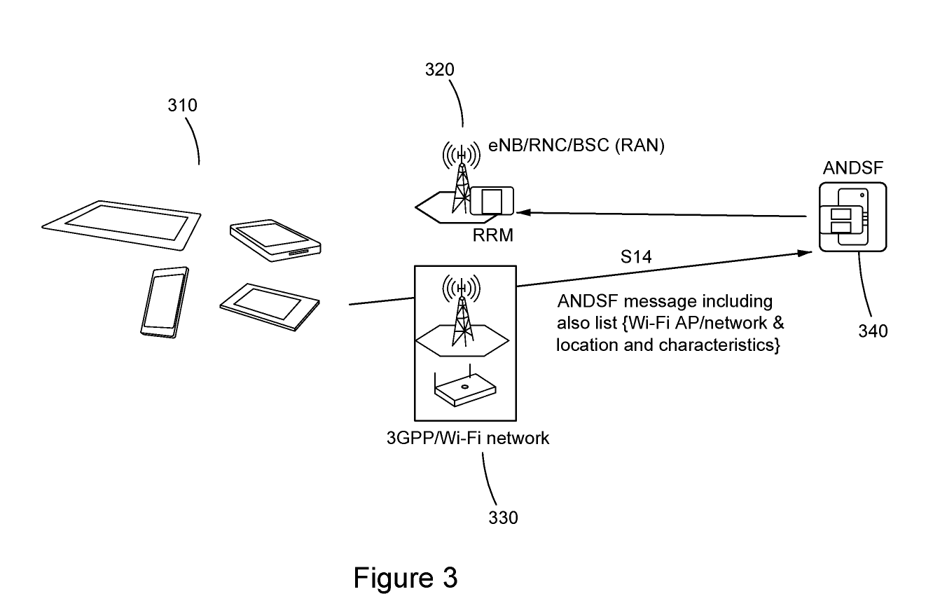

FIG. 3 illustrates an example architecture in which ANDSF server receives UE report and provides meaningful information to RAN. As shown in FIG. 3, an ANDSF server 340 may be in communication with both a Wi-Fi network 330 and a radio access network (RAN) 320. Each of those networks may potentially serve user equipment 310, which can be devices such as tablets or smartphones, as well as other kinds of devices.

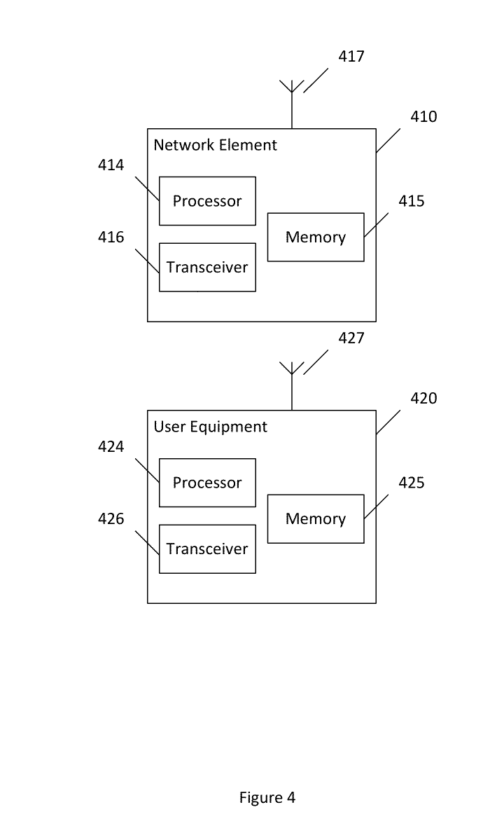

FIG. 4 illustrates a system according to certain embodiments of the invention. It should be understood that each block of the flowchart of FIG. 1, 2, or 5-8 and any combination thereof may be implemented by various means or their combinations, such as hardware, software, firmware, one or more processors and/or circuitry. In one embodiment, a system may comprise several devices, such as, for example, network element 410 and user equipment (UE) or user device 420. The system may comprise more than one UE 420 and more than one network element 410, although only one of each is shown for the purposes of illustration. A network element can be an access point, a base station, an eNode B (eNB), server, host or any of the other network elements discussed herein (see, for example, FIG. 3). Each of these devices may comprise at least one processor or control unit or module, respectively indicated as 414 and 424. At least one memory may be provided in each device, and indicated as 415 and 425, respectively. The memory may comprise computer program instructions or computer code contained therein. One or more transceiver 416 and 426 may be provided, and each device may also comprise an antenna, respectively illustrated as 417 and 427. Although only one antenna each is shown, many antennas and multiple antenna elements may be provided to each of the devices. Other configurations of these devices, for example, may be provided. For example, network element 410 and UE 420 may be additionally configured for wired communication, in addition to wireless communication, and in such a case antennas 417 and 427 may illustrate any form of communication hardware, without being limited to merely an antenna. Likewise, some network elements 410 may be solely configured for wired communication, and such cases antenna 417 may illustrate any form of wired communication hardware, such as a network interface card.

Transceivers 416 and 426 may each, independently, be a transmitter, a receiver, or both a transmitter and a receiver, or a unit or device that may be configured both for transmission and reception. The transmitter and/or receiver may also be implemented as a remote radio head which is not located in the device itself, but in a mast, for example. It should also be appreciated that according to a liquid or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is as software that can run on a server.

A user device or user equipment may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof.

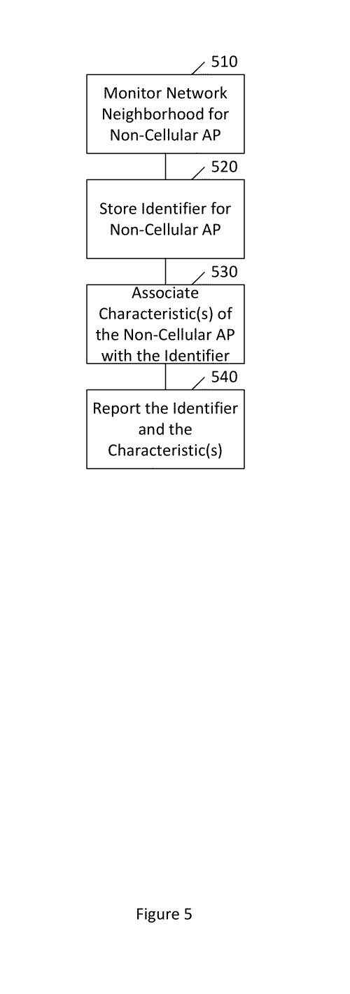

In an exemplary embodiment, an apparatus, such as a node or user device, may comprise means for carrying out embodiments described above in relation to FIG. 1 or 2 or below in relation to FIG. 5-8. In an exemplary embodiment, an apparatus, such as a user device, may comprise means (424) for associating at least one characteristic of the non-cellular access point with the identifier. Another exemplary apparatus, such as a node, may comprise means (414) for creating a neighborhood network map based on a report that includes an identifier of a non-cellular access point and at least one characteristic associated with the non-cellular access point.

Processors 414 and 424 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may comprise modules or unit of at least one chip set, for example, procedures, functions, and so on. Memories 415 and 425 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity may be internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 410 and/or UE 420, to perform any of the processes described above (see, for example, FIGS. 1, 2, and 5-8). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, or the like, or a low-level programming language, such as a machine language, or assembler. Alternatively, certain embodiments of the invention may be performed entirely in hardware.

Furthermore, although FIG. 4 illustrates a system including a network element 410 and a UE 420, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

FIG. 5 illustrates a method according to certain embodiments. The method of FIG. 5 may be performed by, for example, a user equipment. As shown in FIG. 5, a method may include, at 510, monitoring a network neighborhood for a non-cellular access point. The non-cellular access point may be a Wi-Fi AP, for example. The method may also include, at 520, storing an identifier of a non-cellular access point. The identifier may be generated by the UE or obtained from the Wi-Fi AP. The method may further include, at 530, associating at least one characteristic of the non-cellular access point with the identifier. The method may additionally include, at 540, reporting the identifier and the at least one characteristic. The characteristic may be any property of the non-cellular access point, as described herein. For example, the characteristic may be location or owner information of the non-cellular access point.

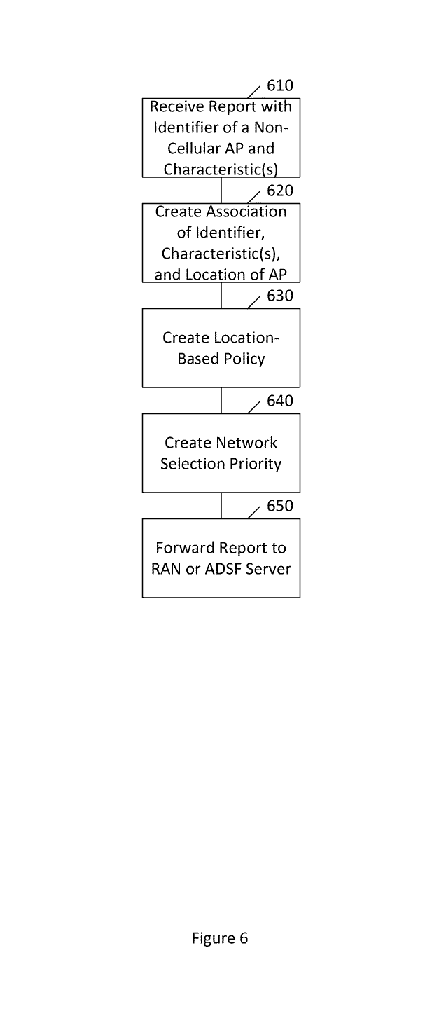

FIG. 6 illustrates a method according to further embodiments. As shown in FIG. 6, a method may include, at 610, receiving a report comprising an identifier of a non-cellular access point and at least one characteristic associated with the non-cellular access point. The method may also include, at 620, creating an association of the identifier, the at least one characteristic, and a location of the non-cellular access point, based on the report. In certain embodiments, the at least one characteristic can be the location, although in other embodiments the at least one characteristic may be other information regarding the non-cellular access point, such information regarding an owner or operator of the non-cellular access point.

The method may also include, at 630, creating a location-based policy based on the report. The method may further include, at 640, creating a network selection priority based on the report. The method may additionally include, at 650, using a network server to determine relevance or the usability of the report.

The method may also include, at 660, forwarding the report to a radio access network or access network discovery and selection function server. The method may further include delivering the report to a neighboring radio access network.

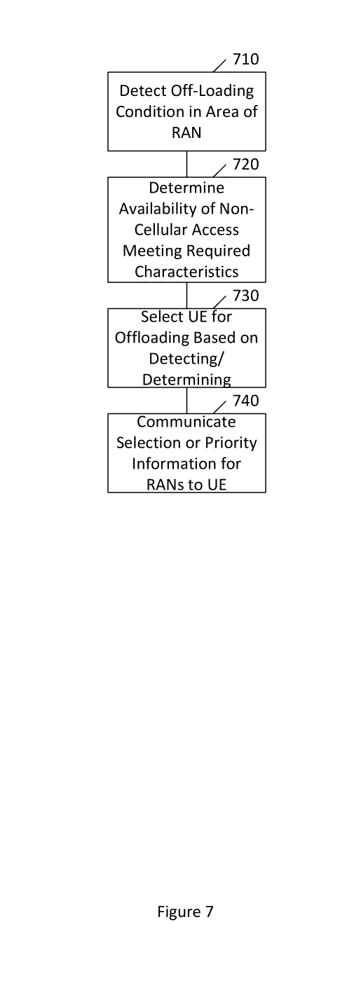

FIG. 7 illustrates a method according to certain other embodiments. As shown in FIG. 7, a method may include, at 710, detecting an off-loading condition in an area of a radio access network. The method may also include, at 720, determining whether non-cellular access meeting required characteristics is available. The method may further include, at 730, selecting a user equipment for moving to non-cellular access based on the detecting and determining.

The determining whether the non-cellular access meeting required characteristics is available may include comparing a characteristic of at least one non-cellular access point to a service requirement of the user equipment. Service requirements can refer to either or both of, for example, QoS and, for example, user profile requirements, such as gold user as opposed to bronze user.

The method may also include, at 740, communicating to the user equipment at least one selection or priority information for radio access technologies, wherein the selection or priority information is configured to cause the user equipment to move to non-cellular access.

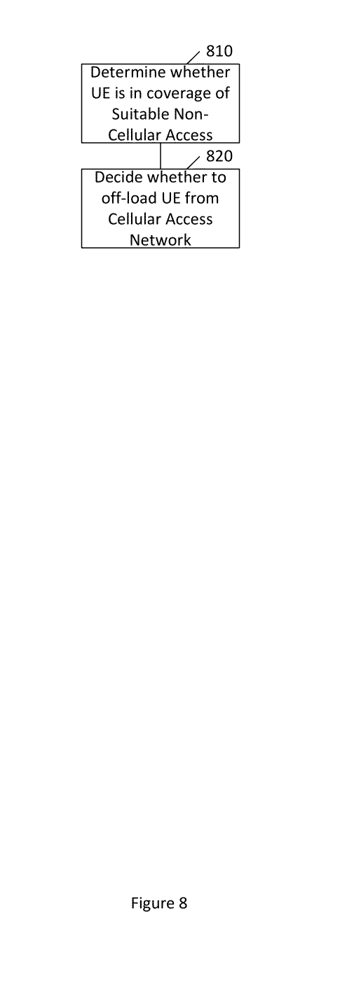

FIG. 8 illustrates an additional method according to certain embodiments. As shown in FIG. 8, a method may include, at 810, determining whether a user equipment is within coverage of non-cellular access meeting required characteristics. The method may also include, at 820, deciding whether to off-load the user equipment from a cellular access network based on the determining.

One having ordinary skill in the art will readily understand that the invention as discussed above may be practiced with steps in a different order, and/or with hardware elements in configurations which are different than those which are disclosed. For example, although Wi-Fi is used as an illustration of one kind of non-cellular access, other kinds of non-cellular access such as WiMAX are also permitted. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

3G Third Generation

3GPP Third Generation Partnership Project

ANDSF Access Network Discovery and Selection Function

ANQP Access Network Query Protocol

ANR Automated Neighboring Relations

AP Access Point

BSC Base Station Controller

eNB eNode B

FQDN Fully Qualified Domain Name

HetNet Heterogeneous Networks, for example 3GPP and Wi-Fi, WiMAX not excluded

HO Handover

LTE Long Term Evolution

MAC Medium Access Control

MME Mobility Management Entity

PLMN Public Land Mobile Network

QoE Quality of Experience

QoS Quality of Service

RAN Radio Access Network

RNC Radio Network Controller

RRC Radio Resource Control

RRM Radio Resource Manager

SSID Service Set Identifier

UE User Equipment

WAN Wide Area Network

We claim:

1. A method, comprising:
monitoring network neighborhood for a non-cellular access point;
storing an identifier of a non-cellular access point;
associating at least one characteristic of the non-cellular access point with the identifier; and
reporting the identifier and the at least one characteristic.

2. A method, comprising:
receiving a report comprising an identifier of a non-cellular access point and at least one characteristic associated with the non-cellular access point; and
creating an association of the identifier, the at least one characteristic, and a location of the non-cellular access point, based on the report.

3. The method of claim 2, further comprising:
creating a location-based policy based on the report.

4. The method of claim 2, further comprising:
creating a network selection priority based on the report.

5. The method of claim 2, further comprising:
using a network server to determine relevance or the usability of the report.

6. The method of claim 2, further comprising:
forwarding the report to a radio access network or access network discovery and selection function server.

7. The method of claim 2, further comprising:
delivering the report to a neighboring radio access network.

8. A method, comprising:
detecting an off-loading condition in an area of a radio access network;
determining whether non-cellular access meeting required characteristics is available; and
selecting a user equipment for moving to non-cellular access based on the detecting and determining.

9. The method of claim 8, wherein the determining whether the non-cellular access meeting required characteristics is available comprises comparing a characteristic of at least one non-cellular access point to a service requirement of the user equipment.

10. The method of claim 8, further comprising:
communicating to the user equipment at least one selection or priority information for radio access technologies, wherein the selection or priority information is configured to cause the user equipment to move to non-cellular access.

11. A method, comprising:
determining whether a user equipment is within coverage of non-cellular access meeting required characteristics; and
deciding whether to off-load the user equipment from a cellular access network based on the determining.

12. An apparatus, comprising:
at least one processor; and
at least one memory including computer program code,
wherein the at least one memory and the computer program code are configured to, with the at least one processor, cause the apparatus at least to
monitor network neighborhood for a non-cellular access point;
store an identifier of a non-cellular access point;
associate at least one characteristic of the non-cellular access point with the identifier; and
report the identifier and the at least one characteristic.

13. An apparatus, comprising:
at least one processor; and
at least one memory including computer program code,
wherein the at least one memory and the computer program code are configured to, with the at least one processor, cause the apparatus at least to
receive a report comprising an identifier of a non-cellular access point and at least one characteristic associated with the non-cellular access point; and
create an association of the identifier, the at least one characteristic, and a location of the non-cellular access point, based on the report.

14. The apparatus of claim 13, wherein the at least one memory and the computer program code are configured to, with the at least one processor, cause the apparatus at least to create a location-based policy based on the report.

15. The apparatus of claim 13, wherein the at least one memory and the computer program code are configured to, with the at least one processor, cause the apparatus at least to create a network selection priority based on the report.

16. The apparatus of claim 13, wherein the at least one memory and the computer program code are configured to, with the at least one processor, cause the apparatus at least to use a network server to determine relevance or the usability of the report.

17. The apparatus of claim 13, wherein the at least one memory and the computer program code are configured to, with the at least one processor, cause the apparatus at least to forward the report to a radio access network or access network discovery and selection function server.

18. The apparatus of claim 13, wherein the at least one memory and the computer program code are configured to, with the at least one processor, cause the apparatus at least to deliver the report to a neighboring radio access network.

19. An apparatus, comprising:
at least one processor; and
at least one memory including computer program code,
wherein the at least one memory and the computer program code are configured to, with the at least one processor, cause the apparatus at least to
detect an off-loading condition in an area of a radio access network;
determine whether non-cellular access meeting required characteristics is available; and
select a user equipment for moving to non-cellular access based on the detected off-loading condition and the determined availability of non-cellular access meeting required characteristics.

20. The apparatus of claim 19, wherein the at least one memory and the computer program code are configured to, with the at least one processor, cause the apparatus at least to determine whether the non-cellular access meeting required characteristics is available by comparing a characteristic of at least one non-cellular access point to a service requirement of the user equipment.

21. The apparatus of claim 19, wherein the at least one memory and the computer program code are configured to, with the at least one processor, cause the apparatus at least to communicate to the user equipment at least one selection or priority information for radio access technologies, wherein the selection or priority information is configured to cause the user equipment to move to non-cellular access.

22. An apparatus, comprising:
at least one processor; and
at least one memory including computer program code,
wherein the at least one memory and the computer program code are configured to, with the at least one processor, cause the apparatus at least to
determine whether a user equipment is within coverage of non-cellular access meeting required characteristics; and
decide whether to off-load the user equipment from a cellular access network based on the determining.
